(19) United States
(12) Patent Application Publication
(10) Pub. No.: US 2010/0073797 A1
(43) Pub. Date: Mar. 25, 2010

(54) STORAGE DEVICE AND METHOD OF CONTROLLING STORAGE DEVICE

(75) Inventor: Yuichi Yamada, Higashiyamato-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/628,917

(22) Filed: Dec. 1, 2009

Related U.S. Application Data
(63) Continuation of application No. PCT/JP2007/061172, filed on Jun. 1, 2007.

(51) Int. Cl. G11B 27/36; G11B 21/02

(52) U.S. Cl. 360/31; 360/75; G9B/21.003

(57) ABSTRACT

According to one embodiment, a storage device includes a target track write module and a test pattern read module. The target track write module performs a write operation on a target track, which is a predetermined track intersecting a test pattern, on a storage medium to which the test pattern is written. The test pattern intersects a plurality of tracks arranged at regular intervals and is continuously arranged over the tracks. The test pattern read module reads the test pattern overwritten by the target track write module.

### CROSS-REFERENCE TO RELATED APPLICATIONS

This application is a continuation of PCT international application Ser. No. PCT/JP2007/061172 filed on Jun. 1, 2007 which designates the United States, incorporated herein by reference.

### BACKGROUND

1. Field

One embodiment of the invention relates to a storage device for detecting a leakage magnetic field of a head and a storage device control method.

2. Description of the Related Art

When a hard disk drive (HDD) device is used for a long time and a write operation is repeatedly performed on one track, data may be erased in tracks adjacent thereto (adjacent tracks or tracks separated from the track by two or more tracks). This phenomenon is caused by a leakage magnetic field generated from regions other than a write gap due to the shape of a write element or the excessive application of write current. Since the leakage magnetic field is weak, data in the track is not adversely affected by several write operations. However, when the write operation is performed several thousands of times or more, data in adjacent tracks is adversely affected by the repetitive write operations. This phenomenon needs to be prevented in the HDD device from the viewpoint of data security.

An erase test for detecting the above phenomenon will be described. First, the HDD device writes data to several tracks to several tens of tracks (adjacent tracks) on both sides (on the inner/outer sides) of a target track. Then, the HDD device writes data to the target track a plurality of times (several hundreds times to several tens of thousands of times). Then, the HDD device measures the characteristics of adjacent tracks and determines whether the characteristics satisfy specifications. Examples of the characteristics include the output voltage of the head, the error rate of the read adjacent track, and viterbi trellis margin (VTM) of the read adjacent tracks. Besides, the specifications may be, for example, the threshold value of the absolute value of the characteristics, the threshold value of the deterioration of the characteristics, and the like.

FIG. 13 is a plan view for explaining a first example of the erase test. FIG. 13 illustrates the positional relationship among tracks A, B, and C on a medium, an upper magnetic pole 71, a lower magnetic pole 72, a write gap 73, and a leakage magnetic field 74 in the erase test. In this case, the write gap 73 is located on the track B, and the leakage magnetic field 74 is located on the track C. As illustrated in FIG. 13, the leakage magnetic field 74 is generated from, for example, an end of the magnetic pole. In this state, when the write gap 73 is used to repeatedly perform a write operation on the track B, the leakage magnetic field 74 erases the data pattern of the track C. Therefore, the generation of the leakage magnetic field 74 is detected.

For example, Japanese Patent Application Publication (KOKAI) No. 2004-79167 discloses, as a conventional technology, servo information record/test method in a disk drive that minimizes the influence of a gap erase field on the servo information recorded on adjacent cylinders.

In the erase test, it is premised that a leakage magnetic field causing the erase of adjacent tracks is always located on adjacent tracks and has an adverse effect on the characteristics of the adjacent tracks. However, when the leakage magnetic field is located between the tracks or at the end of the track due to the shape of a write head or the skew angle of a measurement target, the leakage magnetic filed is likely to pass the test without any influence on the measurement result.

FIG. 14 is a plan view for explaining a second example of the erase test. FIG. 14 illustrates the positional relationship among the tracks A, B, and C on a medium, a head, and the leakage magnetic field 74. The head comprises the upper magnetic pole 71, the lower magnetic pole 72, and the write gap 73. In this case, a track width is in the range of about 0.2 μm to 0.3 μm, the width of the upper magnetic pole 71 is in the range of about 0.2 μm to 0.3 μm, and the height of the upper magnetic pole 71 is in the range of about 0.01 μm to 4 μm.

In FIG. 14, the write gap 73 is located on the track B, and the leakage magnetic field 74 is located between the track B and the track C. In this state, even when the write gap 73 is used to repeatedly perform a write operation on the track B, the leakage magnetic field 74 does not erase a data pattern. Therefore, the generation of the leakage magnetic field 74 is not detected.

In addition, a method has been proposed which performs a test at a plurality of skew angles. However, since the erase test requires repetitive write operations, the test time is long even at one skew angle. Therefore, when the test is performed at a plurality of skew angles, the test time further increases.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an STW device according to an embodiment of the invention;

FIG. 2 is an exemplary flowchart of the operation of the STW device in the embodiment;

FIG. 3 is an exemplary flowchart of a servo write process in the embodiment;

FIG. 4 is an exemplary plan view of all servo patterns written by an STW device according to a comparative example;

FIG. 5 is an exemplary plan view of a portion of the servo patterns written by the STW device according to the comparative example;

FIG. 6 is an exemplary enlarged view of a servo pattern and an erase test pattern written by the STW device in the embodiment;

FIG. 7 is an exemplary block diagram of an HDD device in the embodiment;

FIG. 8 is an exemplary flowchart of an erase test in the embodiment;

FIG. 9 is an exemplary graph of a first example of an output profile in the embodiment;

FIG. 10 is an exemplary graph of a second example of the output profile in the embodiment;

FIG. 11 is an exemplary graph of a third example of the output profile in the embodiment;

FIG. 12 is an exemplary graph of a fourth example of the output profile in the embodiment;

FIG. 13 is an exemplary plan view for explaining a first example of the erase test; and

FIG. 14 is an exemplary plan view for explaining a second example of the erase test.

### DETAILED DESCRIPTION

Various embodiments according to the invention will be described hereinafter with reference to the accompanying drawings. In general, according to one embodiment of the invention, a storage device comprises a target track write module and a test pattern read module. The target track write module is configured to perform a write operation on a target track, which is a predetermined track intersecting a test pattern, on a storage medium to which the test pattern is written. The test pattern intersects a plurality of tracks arranged at regular intervals and is continuously arranged over the tracks. The test pattern read module is configured to read the test pattern overwritten by the target track write module.

According to another embodiment of the invention, there is provided a storage device control method comprising: writing on storage medium a test pattern which intersects a plurality of tracks arranged at regular intervals and is continuously arranged over the tracks; performing a write operation on a target track, which is a predetermined track intersecting the test pattern on the storage medium; and reading the test pattern overwritten by the write operation.

A servo track write (STW) device and an HDD device for performing an erase test according to an embodiment of the invention will be described.

First, the structure of the STW device according to the embodiment will be described.

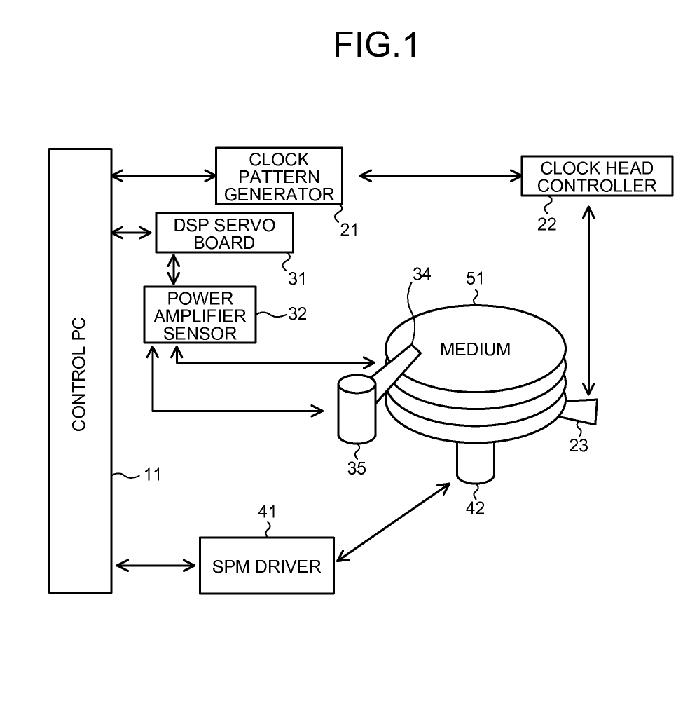

FIG. 1 is a block diagram of the STW device of the embodiment. The STW device comprises a control personal computer (PC) 11, a clock pattern generator 21, a clock head controller 22, a clock head 23, a digital signal processor (DSP) servo board 31, a power amplifier sensor 32, a head 34, a voice coil motor (VCM) 35, a spindle motor (SPM) driver 41, and an SPM 42. A plurality of media 51 (magnetic storage media and magnetic disks) are attached to the STW device. The lowest medium of the media 51 is a dummy medium.

The control PC 11 controls the clock pattern generator 21, the DSP servo board 31, and the SPM driver 41. The clock pattern generator 21 generates a clock pattern according to an instruction from the control PC 11 and sends the clock pattern to the clock head controller 22. The clock head controller 22 sends the clock pattern to the clock head 23. The clock head 23 writes the clock pattern to the dummy medium.

The DSP servo board 31 controls the power amplifier sensor 32 according to an instruction from the control PC 11. The power amplifier sensor 32 controls the VCM 35 and the head 34 according to an instruction from the DSP servo board 31. The VCM 35 moves the head 34 according to an instruction from the power amplifier sensor 32. The head 34 writes signals from the power amplifier sensor 32 to the medium 51. The SPM driver 41 controls the SPM 42 according to an instruction from the control PC 11. The SPM 42 drives the media 51 according to an instruction from the SPM driver 41.

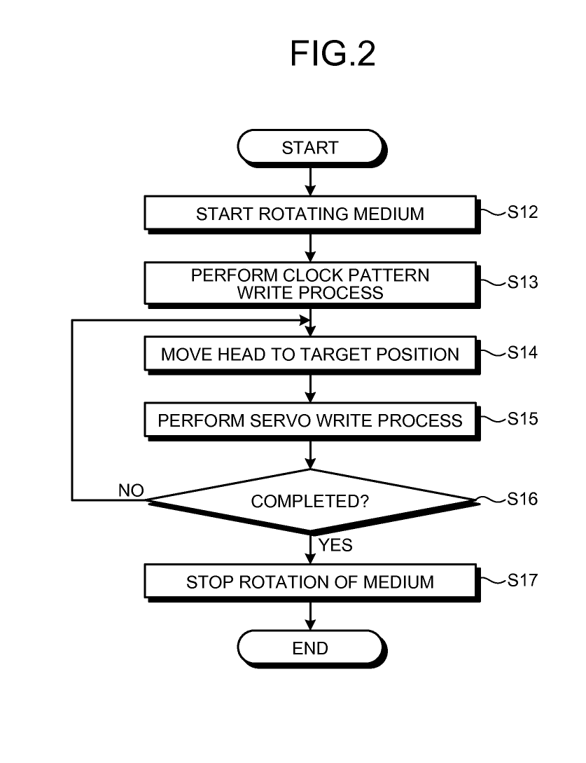

Next, the operation of the STW device according to the embodiment will be described. FIG. 2 is a flowchart of an example of the operation of the STW device according to the embodiment. First, when the medium 51 is attached to the STW device, the SPM driver 41 and the SPM 42 start rotating the medium 51 according to an instruction from the control PC 11 (S12). Then, the clock pattern generator 21 performs a clock pattern write process according to an instruction from the control PC 11 (S13). In the clock pattern write process, the clock pattern generator 21 generates a clock pattern, and the clock head controller 22 sends the clock pattern to the clock head 23. Then, the clock head 23 writes the clock pattern to the dummy medium.

Then, the DSP servo board 31 and the power amplifier sensor 32 move the head 34 to a target position in the radius direction of the medium according to an instruction from the control PC 11 (S14). Then, the DSP servo board 31 performs a servo write process (test pattern write) corresponding to one revolution according to an instruction from the control PC 11 (S15). In the servo write process, the DSP servo board 31 sends a servo write instruction to the power amplifier sensor 32, and the power amplifier sensor 32 sends a servo pattern or an erase test pattern to the head 34. Then, the head 34 writes the received pattern to the medium 51.

Then, the control PC 11 determines whether the servo write process for the entire surface of the medium. 51 is completed. If it is determined that the servo write process is not completed (NO at S16), the process returns to S14. If it is determined that the servo write process is completed (YES at S16), the SPM driver 41 controls the SPM 42 to stop the rotation of the medium 51 according to an instruction from the control PC 11 (S17). Then, the process ends. Thereafter, the medium 51 is separated from the STW device and is then attached to the HDD device.

Next, the servo write process will be described.

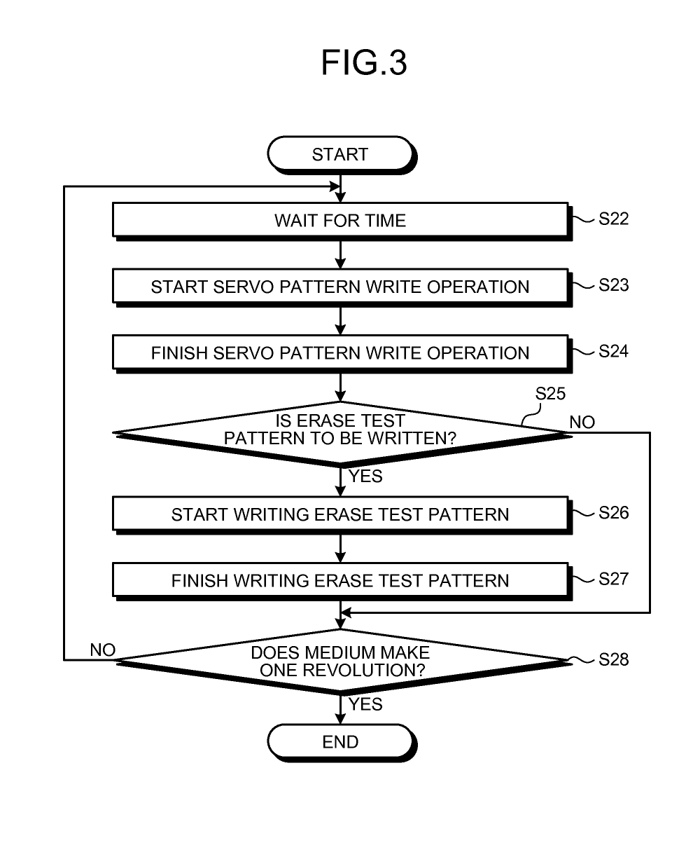

FIG. 3 is a flowchart of an example of the servo write process according to the embodiment. First, when the seeking of a target position is completed, the DSP servo board 31 detects the position of the head 34 in the circumferential direction of the medium based on the clock pattern read by the clock head 23. Then, the DSP servo board 31 waits for the start of a servo pattern write operation based on the position of the head 34 in the circumferential direction of the medium (S22), starts the servo pattern write operation (S23), and finishes the servo pattern write operation (S24). Then, the DSP servo board 31 determines whether to write an erase test pattern (S25). The erase test pattern is written when the position of the head 34 in the circumferential direction of the medium is a predetermined erase test pattern write position.

If it is determined not to write the erase test pattern (NO at S25), the process proceeds to S28. On the other hand, if it is determined to write the erase test pattern (YES at S25), the DSP servo board 31 starts writing the erase test pattern (S26) and finishes writing the erase test pattern (S27). Then, the DSP servo board 31 determines whether the medium makes one revolution (S28). If it is determined that the medium does not make one revolution (NO at S28), the process returns to S22. If it is determined that the medium makes one revolution (YES at S28), the process ends.

The servo write process according to the embodiment is different from a servo write process according to a comparative example in that a new erase test pattern is written between the write servo patterns (S25 to S27).

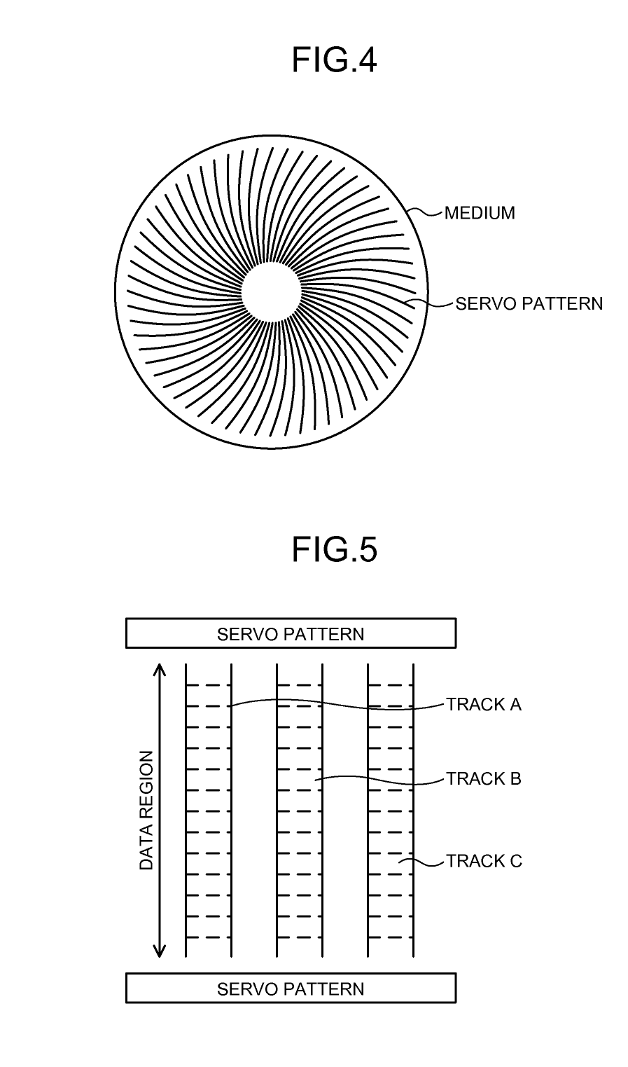

FIG. 4 is a plan view of an example of all servo patterns written by a STW device according to the comparative example. FIG. 4 illustrates the arrangement of the servo patterns on the entire surface of a medium. FIG. 5 is a plan view of an example of a portion of the servo patterns written by the STW device according to the comparative example. FIG. 5 is an enlarged view of a portion of FIG. 4. The servo pattern is continuously written to intersect tracks A, B, and C that are arranged in the circumferential direction of the medium. The servo patterns are written with a predetermined gap therebetween in the circumferential direction of the medium, and a region between the servo patterns is a data region. The width of the servo pattern in the circumferential direction of the medium is about 40 μm, and the gap between the servo patterns in the circumferential direction of the medium is about 700 μm.

FIG. 5 also illustrates the position of the data pattern written by the HDD device. In general, the data pattern is written to the tracks that are arranged in the data region with a predetermined gap therebetween in the radius direction of the medium. When the distance between adjacent tracks is too short, the HDD device simultaneously reads signals from a desired track and adjacent tracks during data read operation, which makes it difficult to reproduce only data read from a desired track. Therefore, a predetermined gap is provided between the tracks and no data pattern is written to the gap.

The servo pattern is for positioning the head and is not provided with the gap between the tracks. In general, when writing a servo pattern corresponding to one revolution, the STW device is moved by a step of ⅕ to ½ of the write core width in the radius direction of the medium and writes a servo pattern corresponding to the next one revolution. Therefore, the servo patterns are continuously written from the inner side to the outer side without any gap therebetween.

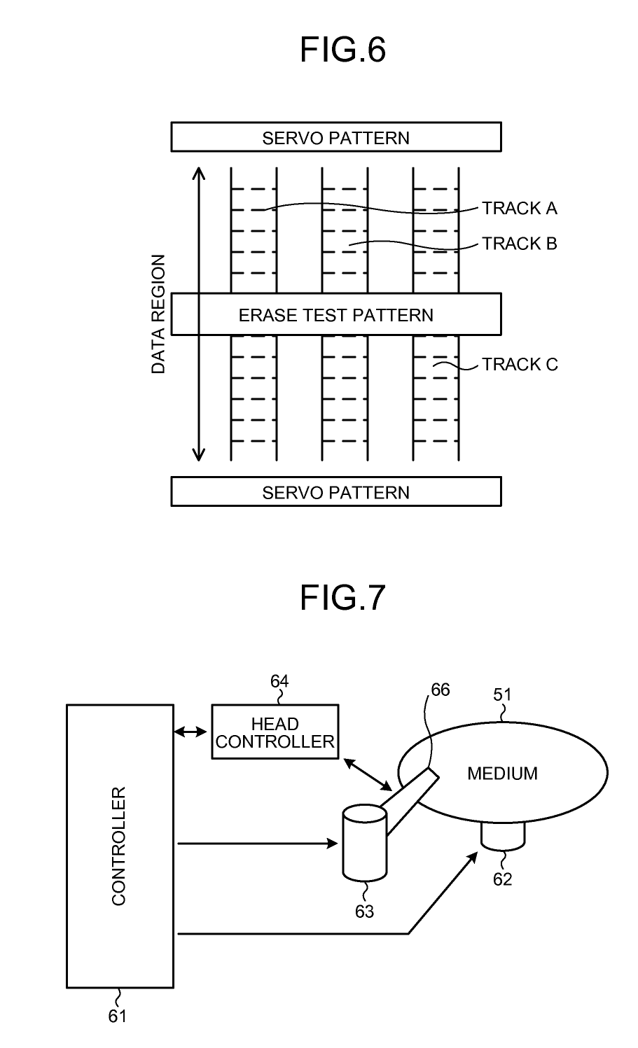

FIG. 6 is an enlarged view of an example of the servo pattern and the erase test pattern written by the STW device according to the embodiment. FIG. 6 illustrates the servo pattern and the erase test pattern with the same scale as in FIG. 5. The arrangement of the servo patterns is the same as that in the comparative example. In the embodiment, in the data region, one erase test pattern having the same shape as the servo pattern is arranged between two predetermined servo patterns. In the embodiment, the erase test pattern is written subsequent to the servo pattern. Therefore, similar to the servo pattern, the erase test pattern is written by a step of ⅕ to ½ of the write core width in the radius direction of the medium.

The erase test pattern may be written to a plurality of regions other than the servo patterns. In addition, a plurality of erase test patterns may be arranged between two predetermined servo patterns.

After the medium having the servo pattern and the erase test pattern written thereon by the STW device is loaded on the HDD device, the erase test pattern is over written with the data pattern written to the track.

Next, the structure of the HDD device according to the embodiment will be described.

FIG. 7 is a block diagram of the HDD device according to the embodiment. The HDD device comprises a controller 61, an SPM 62, a VCM 63, a head controller 64, a head 66, and the medium 51. The controller 61 controls the SPM 62, the VCM 63, and the head controller 64. The SPM 62 drives the medium 51 according to an instruction from the controller 61. The VCM 63 moves the head 66 according to an instruction from the controller 61. The head 66 writes the signal from the head controller 64 to the medium 51 and sends the signal read from the medium 51 to the head controller 64. The head controller 64 sends the signal from the controller 61 to the head 66 and sends the signal from the head 66 to the controller 61.

Next, an erase test operation of the HDD device according to the embodiment will be described.

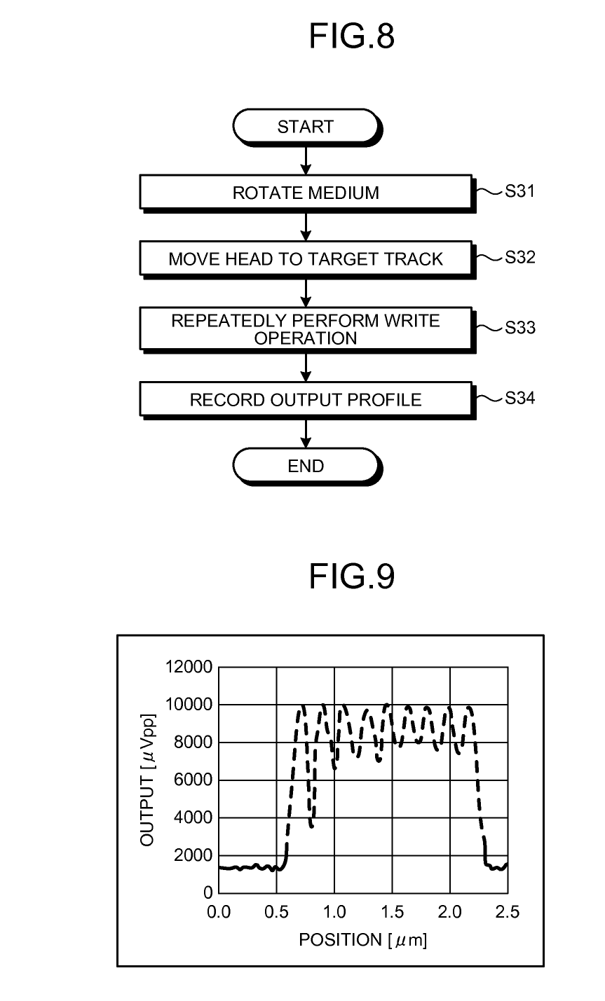

FIG. 8 is a flowchart of an example of the erase test operation according to the embodiment. Before a data pattern is recorded on a medium, the erase test is performed. First, the controller 61 instructs the SPM 62 to rotate the medium 51 (S31). Then, the controller 61 instructs the VCM 63 to move the head 66 to a target track (S32). The target track is a track on which a predetermined repetitive write operation is performed.

Then, the controller 61 repeatedly performs a write operation (target track write) on the target track a predetermined number of times (several hundreds of times to several tens of thousands of times) (S33). In this case, an operation of erasing the target track is performed as the repetitive write operation. Then, the controller 61 instructs the VCM 63 to move the head 66 in the vicinity of the target track. In addition, the controller 61 acquires a voltage output from the head 66 by erase test pattern read (test pattern read) from the head controller 64, and measures an output voltage for the position of the head 66 in the radius direction of the medium as an output profile (S34). Then, the process ends. In the embodiment, the controller 61 acquires the output voltage as the output profile. However, the controller 61 may acquire the error rate of the read erase test pattern or the VTM of the read erase test pattern.

There may be a plurality of target tracks. In this case, the process from S32 to S34 is repeatedly performed on each target track. In addition, before the process from S32 and S33, S34 may be performed to measure an initial output profile and the initial output profile may be compared with the output profile after the repetitive write operation.

A target track write module corresponds to S33 of the controller 61 in the embodiment. In addition, a test pattern read module corresponds to S34 of the controller 61 in the embodiment.

Next, a detailed example of the output profile will be described.

First, a detailed example of the output profile when no leakage magnetic field is generated will be described. FIG. 9 is a graph of a first example of the output profile according to the embodiment. The horizontal axis indicates the position (radius direction position) [μm] of a write gap in the radius direction of the medium and the vertical axis indicates an output voltage [μVpp]. In FIG. 9, the erase test pattern is written in a region at a radius direction position of 2.3 μm or less. The target track is a region at a radius direction position of 0.5 μm or less. It is assumed that a target track region (a radius direction position of 0.5 μm or less) is referred to as a track region, the erase test pattern is written in the track region, and a region (a radius direction position of 0.5 μm to 2.3 μm) other than the track region is referred to as a test region.

When the write gap is used to perform an erase operation on the target track at S33, the output voltage is low in the track region after the erase test. As in the first example of the output profile, when no leakage magnetic field is generated, the erase test pattern remains in the test region and the output voltage is high. In the region in which the erase test pattern is not written, the output voltage is low.

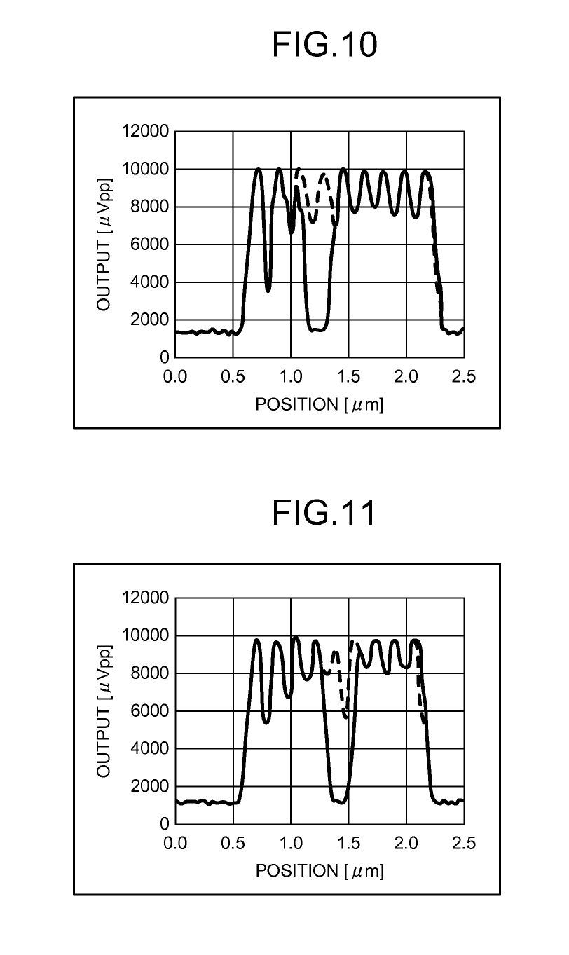

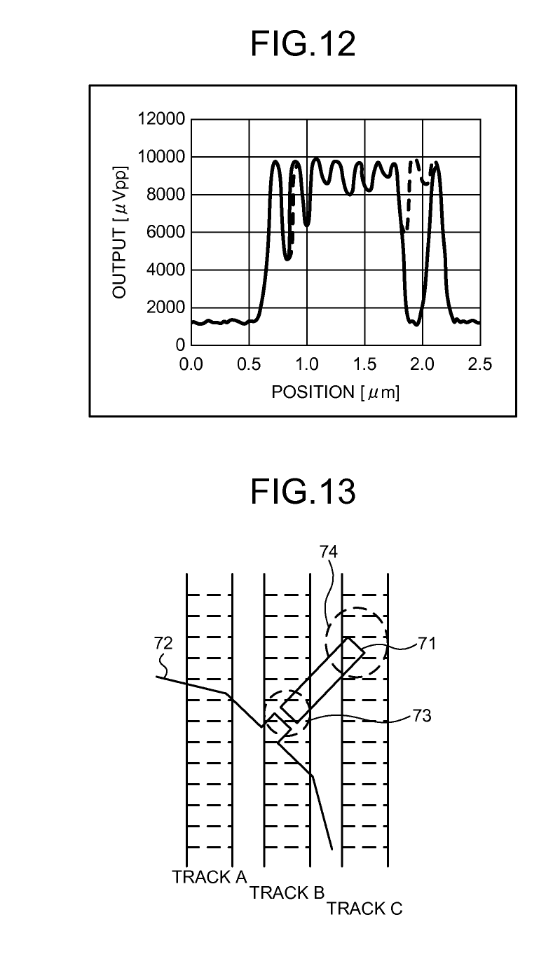

Next, a detailed example of the output profile when a leakage magnetic field is generated will be described. FIG. 10 is a graph of a second example of the output profile according to the embodiment. FIG. 11 is a graph of a third example of the output profile according to the embodiment. FIG. 12 is a graph of a fourth example of the output profile according to the embodiment. In the second to fourth examples of the output profile, the horizontal axis and the vertical axis indicate the position of a write gap and an output voltage, respectively, similarly to the output profile when no leakage magnetic field is generated. In the second to fourth examples of the output profile, a dotted line indicates the output profile of the first example (when no leakage magnetic field is generated) and a solid line indicates the output profile when the leakage magnetic field is generated.

When there is a portion of the test region in which the output voltage is low, it is possible to determine that the erase test pattern is erased by the leakage magnetic field. In the second example of the output profile, the output voltage is low in the vicinity of a radius direction position of 1.2 μm in the test region. Similarly, in the third example of the output profile, the output voltage is low in the vicinity of a radius direction position of 1.4 μm in the test region. Similarly, in the fourth example of the output profile, the output voltage is low in the vicinity of a radius direction position of 1.9 μm in the test region.

The radius direction position where the output voltage is low in the test region corresponds to the radius direction position of the leakage magnetic field. The position varies depending on the shape of the head and a skew angle.

The radius direction position where the erase test pattern is written and the target track of the erase test are determined such that an appropriate skew angle is obtained during the erase test. The appropriate value may be equal to or more than a value capable of discriminating the erase operation by the write gap from the erase operation by the leakage magnetic field.

When the error rate or the VTM is used as the output profile instead of the output voltage, the error rate or the VTM is small at the radius direction position where the erase test pattern remains, and the error rate or the VTM is large at the radius direction position where the erase test pattern is overwritten. Therefore, when the error rate or the VTM that is more than a predetermined value is detected from the test region, it is possible to determine that the leakage magnetic field is generated.

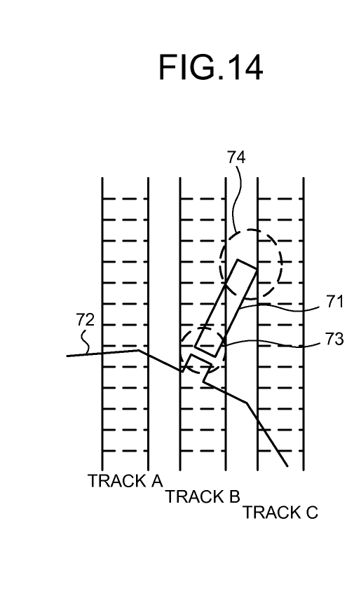

As described above, according to the embodiment, it is possible to detect a leakage magnetic field by erasing data from a medium having an erase test pattern written thereon using repetitive write process and reading the state where the erase test pattern is erased. Moreover, since the erase test pattern intersects the tracks and is continuously arranged between the tracks, it is possible to detect a leakage magnetic field as illustrated in FIG. 14.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a target track writer configured to write a data pattern on a predetermined target track across a test pattern on a storage medium, the test pattern spanning a plurality of tracks arranged at regular intervals and continuously aligned over the tracks; and
a test pattern reader configured to read the test pattern written by the target track writer.

2. The storage device of claim 1, wherein the target track writer is further configured to write on the target track a plurality of times.

3. The storage device of claim 1, wherein the target track writer is further configured to erase the target track.

4. The storage device of claim 1, wherein the test pattern reader is further configured to output a position of a head along the test pattern and a read result of the test pattern at the position.

5. The storage device of claim 4, wherein the read result is at least one of an output voltage from the head, an error rate of the test pattern, and a viterbi trellis margin of the test pattern.

6. The storage device of claim 1, wherein
a plurality of servo patterns are configured to be written on the storage medium, and
at least one test pattern is written between a plurality of predetermined servo patterns.

7. The storage device of claim 6, wherein
the storage medium is a magnetic disk,
the servo patterns are configured to be written in a radius direction of the magnetic disk,
the test pattern is configured to be written in the radius direction of the magnetic disk, and
the tracks are configured to be written in a circumferential direction of the magnetic disk.

8. The storage device of claim 7, wherein the test pattern is configured to be written in a region of the target track where a skew angle is equal to or larger than predetermined degrees.

9. A storage device control method comprising:
writing on storage medium a test pattern across a plurality of tracks at regular intervals and continuously over the tracks;
writing a data pattern on a predetermined target track across the test pattern on the storage medium; and
reading the written test pattern.

10. The storage device control method of claim 9, further comprising writing on the target track a plurality of times.

11. The storage device control method of claim 9, further comprising erasing the target track.

12. The storage device control method of claim 9, further comprising outputting a position of a head along the test pattern and a read result of the test pattern at the position while reading.

13. The storage device control method of claim 12, wherein the read result is at least one of an output voltage from the head, an error rate of the test pattern, and a viterbi trellis margin of the test pattern.

14. The storage device control method of claim 9, further comprising writing a plurality of servo patterns on the storage medium and at least one test pattern between the servo patterns.

15. The storage device control method of claim 14, wherein
the storage medium is a magnetic disk,
further comprising:
writing the servo patterns in a radius direction of the magnetic disk,
writing the test pattern in the radius direction of the magnetic disk, and
writing the tracks in a circumferential direction of the magnetic disk.

16. The storage device control method of claim 15, further comprising writing the test pattern in a region of the target track where a skew angle is equal to or larger than predetermined degrees.
